(19) United States
(12) Patent Application Publication
(10) Pub. No.: US 2025/0305925 A1
(43) Pub. Date: Oct. 2, 2025

(54) METHOD AND APPARATUS FOR DETECTING SOLID PARTICLES IN FLUID FLOW

(71) Applicant: Serge David BRACHE, Calgary (CA)

(72) Inventor: Serge David BRACHE, Calgary (CA)

(21) Appl. No.: 18/621,086

(22) Filed: Mar. 28, 2024

(51) Int. Cl. G01N 15/06; G01N 15/00

(52) U.S. Cl. CPC G01N 15/06; G01N 2015/0053

(57) ABSTRACT

An apparatus, system and method of detecting solid particles in a flow is described herein. A pipe with fluid flow containing solid particles has a thru-pipe mounted intrusive probe. The intrusive probe provides impact surfaces for solid particles. Each particle impact generates an impulse response. The material composition and design shape of the probe determines unique impulse response frequencies, durations, and amplitude envelope. The method and design controls the generation, and facilitates identification of the unique impulse response. The unique impulse response is identified by isolation and extraction of amplitude envelope wavelets. The impulse response or particle impact may be counted to facilitate calculating the quantity of solid particles.

### FIELD

The present disclosure relates to the field of detecting solid particles in pipe flows, and in particular to a method and apparatus of providing particle detection and quantities in the oil and gas industry, and in particular sand.

### BACKGROUND

The following description of the background is not an admission that anything discussed below is common general knowledge. In oil and gas industries or water transport industries, identification and removal of sand is essential to the integrity of these systems. Expensive damages can occur if not mitigated to both equipment and environment. Knowledge of the presence and quantities in the pipe flows are essential in order be able to remove the sand in a timely manner. This information must be gathered and communicated to relevant personnel. Sand detection instruments have been used in the industry sparingly as they have been found difficult to use and of questionable accuracy.

Conventional industrial practice involves mounting particle/sand detectors on the outside of the pipe to detect in the ultrasound band particles striking the pipe walls. These are usually placed after an elbow in the pipe where particles are likely to impact. The requirement to mount these external detectors on elbows complicates pipeline design. The area surface for particle impacts is not well controlled. The quantity of impacts will depend on velocity, where lighter particles in slower velocities may not hit the wall. The location on the pipe where the particles impact varies along the length of the pipe depending on velocity, viscosity, flow regimes and other factors. These dynamics will change as flow regimes change in time in one location, and from site to site. There will also be variations from site to site on pipe thickness, elbow differences and many other variables. The particle impact response will not be repeatable from site to site or mounting location. This variation in signal makes it difficult to manage all the possible signals. All variables, known and unknown, compromise the quality of the data collected and it is challenging to correct for the compounded effects of the above-mentioned variables on the data collected. Field calibration may be required on installation and may need to be redone if variables change substantially on any one installation.

### SUMMARY

An apparatus, system and method of detecting solid particles in a flow is described herein.

In an aspect of the present disclosure, provided is a method of detecting solid particles in a fluid flow comprising: providing a probe into the fluid flow, the probe adapted to vibrate at a frequency in an impulse response envelope to the solid particles; and detecting the frequency and impulse response envelope.

In an embodiment disclosed, the frequency is in an ultrasonic range.

In an embodiment disclosed, the frequency is predetermined by mechanical configuration of the probe.

In an embodiment disclosed, detecting the frequency comprises extracting wavelets from the impulse response.

In an aspect of the present disclosure, provided is a system for detecting solid particles in a fluid flow comprising: a probe for insertion into the fluid flow, the probe adapted to vibrate at a frequency in an impulse response envelope to the solid particles; a piezoelectric device in ultrasonic communication with the probe, adapted to convert impulse response vibration into an electronic signal; and a detector, adapted to identify the impulse response in the electronic signal.

In an embodiment disclosed, the system further comprises a section pipe, the probe inserted through a wall of the section of pipe into the fluid flow.

In an embodiment disclosed, the probe has an impact face proximate a first end of the probe and a sensor mounting surface in ultrasonic acoustic communication with the impact face, wherein the impact face is adapted to intrude into the fluid flow, and wherein the piezoelectric device is affixed to the sensor mounting surface.

In an embodiment disclosed, the probe is at least partially hollow. In an embodiment disclosed, the probe is substantially hollow. In an embodiment disclosed, a portion proximate the impact face is substantially solid and a portion distal the impact face is hollow.

In an embodiment disclosed, the impact face is angled relative to a body of the probe.

In an embodiment disclosed, the impact face is angled relative to a direction of the fluid flow.

In an embodiment disclosed, the system further comprises a section of pipe and a ring on an outside of the section of pipe, wherein the probe comprises a shaped tubular inside the section of pipe, the shaped tubular having an impact face and the ring having a sensor mounting surface, wherein the impact face and the sensor mounting surface are in ultrasonic acoustic communication.

In an embodiment disclosed, the ring is proximate the impact face.

In an embodiment disclosed, the shaped tubular comprises a cross-section profile, wherein the cross-section profile is triangular.

In an embodiment disclosed, the probe, the section of pipe, and the ring are a unitary body.

In an aspect of the present disclosure, provided is a probe for insertion into a fluid flow for detecting solid particles in the fluid flow, the probe adapted to vibrate at a frequency and impulse response envelope to the solid particles, the probe comprising: an impact face proximate a first end of the probe and a sensor mounting surface in ultrasonic acoustic communication with the impact face, the impact face adapted to intrude into the fluid flow.

In an embodiment disclosed, the probe further comprises a section of pipe and a ring on an outside of the section of pipe, wherein the probe comprises a shaped tubular inside the section of pipe, the shaped tubular having the impact face and the ring having the sensor mounting surface.

In an embodiment disclosed, the probe further comprises a piezoelectric device in ultrasonic acoustic communication with the probe, adapted to convert impulse response vibration into an electronic signal.

Other aspects and features of the present disclosure will become apparent to those ordinarily skilled in the art upon review of the following description of specific embodiments of the disclosure in conjunction with the accompanying figures.

### BRIEF DESCRIPTION OF DRAWINGS

In drawings which illustrate embodiments:

FIG. 1 is a block diagram representation of an apparatus of the present disclosure;

FIG. 2a1-2b2 are diagrams of various probe designs of the present disclosure;

FIGS. 3-3a are diagrams of a further embodiment of a probe of the present disclosure;

FIGS. 4a-4c are diagrams of various mounting options of a probe of the present disclosure;

FIG. 5 is a diagram showing the designed invention vibrations in a probe of the present disclosure;

FIG. 6 is an electrical capture of the vibrations of a physical implementation of a probe, in time;

FIG. 7 is an electrical capture of the vibrations of a physical implementation of a probe, showing frequencies;

FIGS. 8a-8c are diagrams of a piezoelectric device (piezo) design and connection of the present disclosure;

FIG. 9 is an electronics block diagram of the present disclosure;

FIG. 10 is an electronic filter frequency pass band of the second order filter block;

FIG. 11 is an electronic signal (wavelet) in time fed to the microprocessor;

FIG. 12 is a superposition of the wavelet and the electrical capture of vibrations;

FIG. 13 is a software correlation state diagram identifying impacts (strikes);

FIG. 14 is an electronic time sequence of a set of overlapping wavelets, and counting thereof;

FIG. 15 is an electronic time sequence of a very large number of overlapping wavelets (saturated), and counting thereof;

FIG. 16 is an example of a conversion factor table used to convert energy to mass; and

FIG. 17 is an example of sand concentrations used to build the conversion factor table.

### DETAILED DESCRIPTION

### Overview

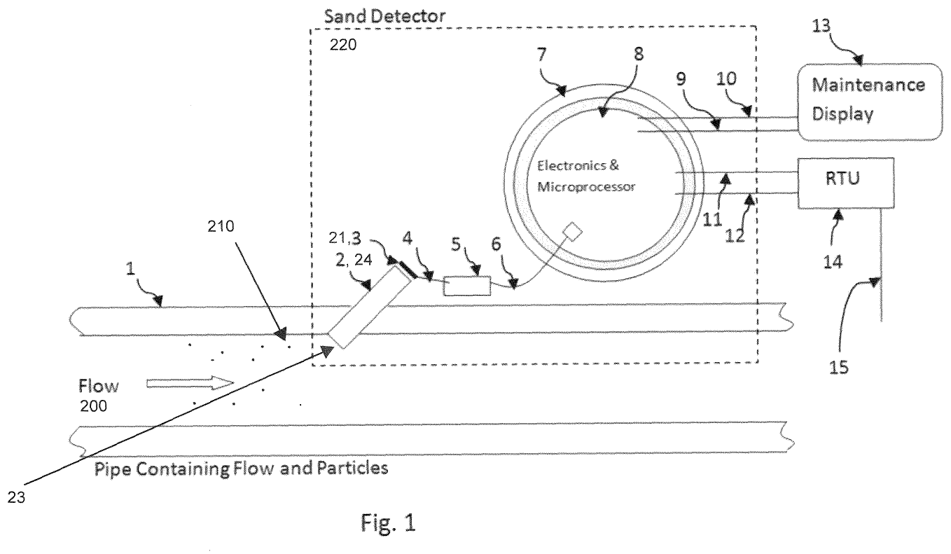

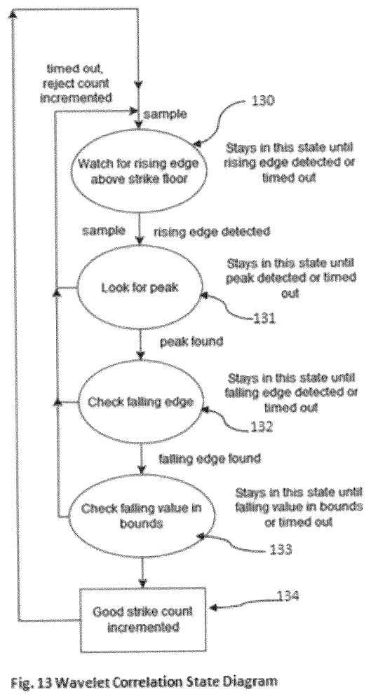

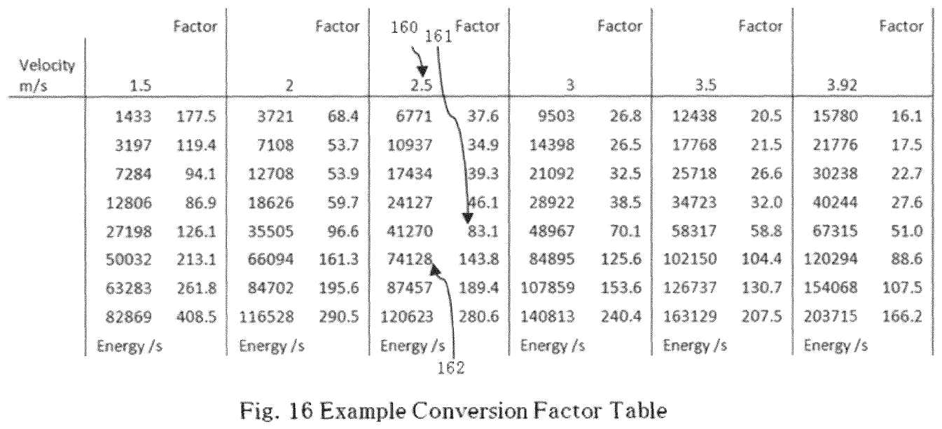

Referring to FIG. 1, a sand detector according to an embodiment is shown generally at 220. A probe 24 having an impact face 23 is inserted and protrudes into a pipe 1 and into a fluid flow 200 which may contain particles 210. A piezoelectric device 3 is attached to an opposite end of the probe 24 to convert the mechanical vibrations into an electrical signal. These signals are received by electronics and microprocessor 8 which amplifies filters, adjusts the gain, and follows the signal envelope. A microprocessor digitizes the signal from the piezoelectric device 3 and correlates the signal against the designed wavelet for the probe design (see e.g. FIG. 13). This correlation identifies wavelets in the signal corresponding to particle impacts. This provides detection of the presence of particles 210 in flow 200 and quantity of impacts (see e.g. FIG. 13). The energy of this information is measured, and the energy is converted to mass, based on energy received and velocity (see e.g. equation (1) and FIG. 16). The results are made available to a remote terminal unit (RTU) 14 for local display and/or for communications back to a host.

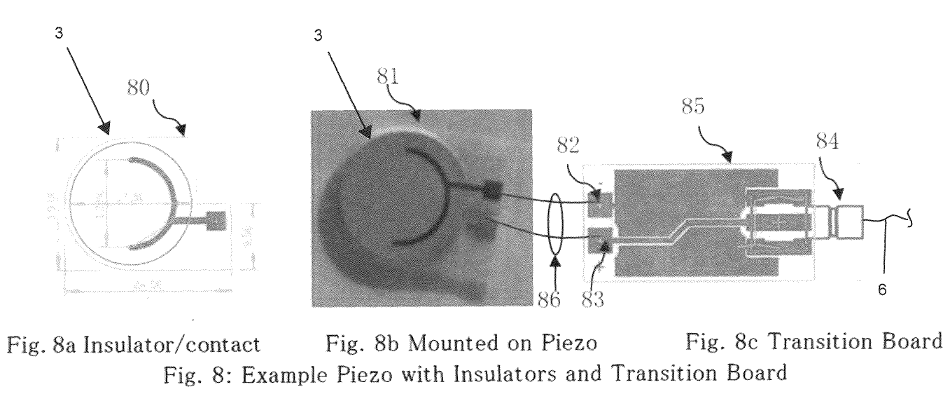

Also shown in FIG. 1 is transition board 5, which optionally connects between the piezoelectric device 3 and the electronics and microprocessor 8 (see also FIGS. 8a-8c). In an embodiment disclosed wire pair 4, 86 may be relatively fine and/or relatively short in order to reduce vibration. For longer lengths, to reduce change of breaking, transition board 5, 85 is fixedly mounted relatively close to piezoelectric device 3, and provides a transition from wire pair 4, 86 to coax cable 6, 84. Coax cable 6, 84 then delivers the signal to the electronics and microprocessor 8 in electronics housing 7, which may be some distance from the probe 24 and/or piezoelectric device 3.

A removable maintenance display terminal 13 is connectable to programming port 10 and provides maintenance port communications 9.

Remote terminal unit 14 provides a connection 15 to a host (not shown) as well as power supply 11 and data communication, for example by RS 485 modbus communications 12, to/from sand detector 220.

### Probe Design

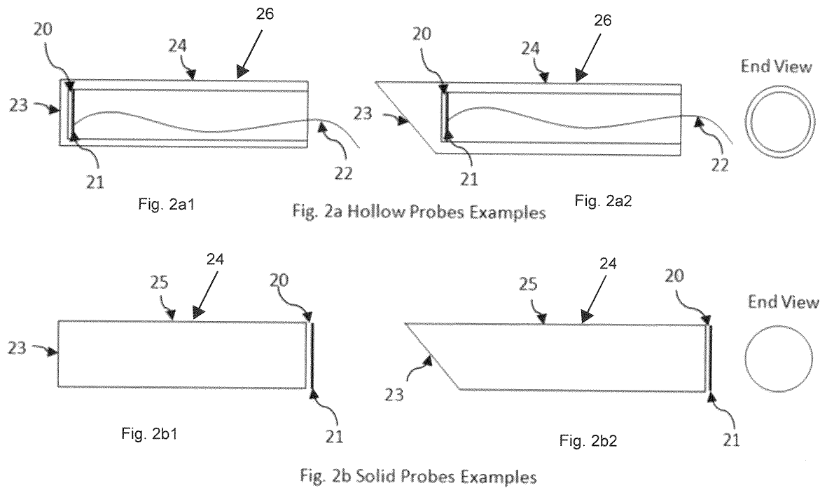

Referring to FIG. 2a1-2b2, probe 24 may be at least partly hollow to provide a hollow probe 26 (see FIGS. 2a1 and 2a2) or substantially solid to provide a solid probe 25 (see FIGS. 2b1 and 2b2). In an embodiment disclosed, probe 24 may be substantially cylindrical. In a hollow probe 26, a central bore extends into the probe 24. The central bore may extend substantially the length of the hollow probe 26 (see e.g. FIG. 2a1, 2a2) or may extend only a portion of the length of the hollow probe 26, for example about ⅓, ½ or ⅔ the length (not shown) of the hollow probe 26. The probe 24 has an impact face 23 which may be substantially perpendicular (see FIG. 2a1, 2b1) or angled (see FIG. 2a2, 2b2) relative to a length of probe 24. In an embodiment disclosed, impact face 23 may be angled, for example between about 30 degrees and about 50 degrees, relative to a longitudinal axis of the probe 24. In an embodiment disclosed, impact face 23 is angled at about 45 degrees.

A piezoelectric device 3, 21 is affixed to the probe 24 at surface 20. In an embodiment disclosed, the piezoelectric device 3, 21 is affixed by epoxy. Surface 20 is an internal face of the impact face 23 for hollow probe 26 (see FIG. 2a1, 2a2). Comparatively, FIG. 2b1, 2b2 identifies placement of the piezoelectric device 3, 21 on the terminus of a solid probe 25 opposite the impact face 23 inserted into the flow 200. Probe design parameters generate unique vibration responses to solid particle impacts. In particular, the impulse response from a particle impact depends on the shape, size, mounting, and material composition of the probe. The present disclosure includes variations in probe length, probe diameter, and flow insertion terminus end shape (see impact face 23). In an embodiment disclosed, probe 24, whether a solid probe 25 or a hollow probe 26, is designed to provide specific vibration response parameters. Probe 24 is preferably generally or substantially cylindrical to provide a simpler vibration signal.

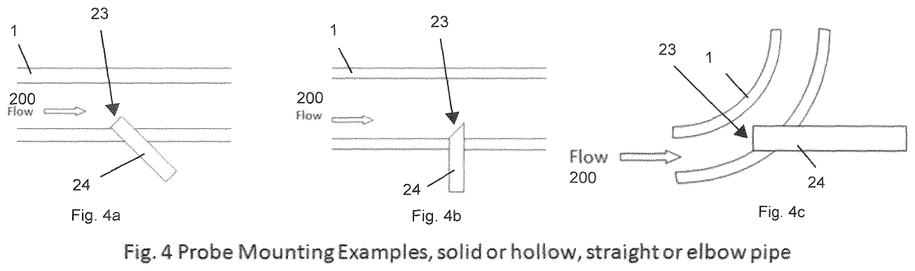

In an embodiment disclosed, impact face 23 is at an angle relative to the flow 200 when installed. In an embodiment disclosed, the angle relative to the flow 200 is between about 30 degrees and about 50 degrees, and in an embodiment about 45 degrees. The probe 24 may be configured for angled insertion (see FIG. 1, 4a, 4c) or vertically into a horizontal pipe 1 (see FIG. 4b) insertion.

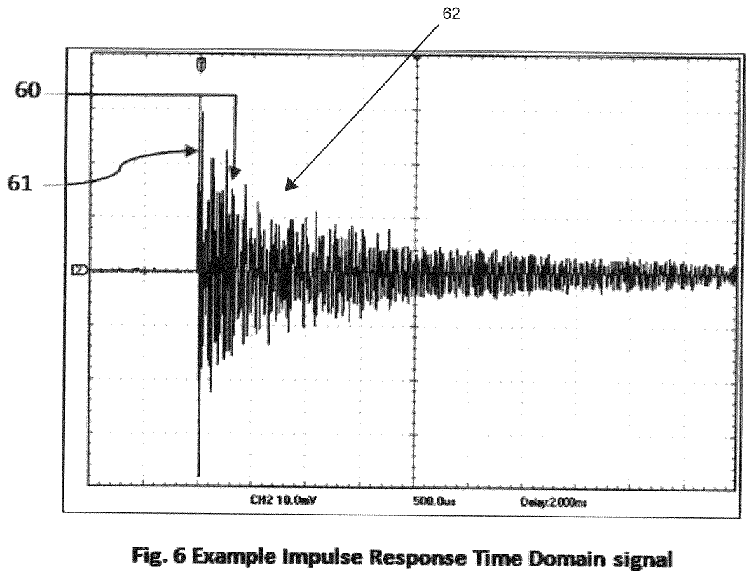

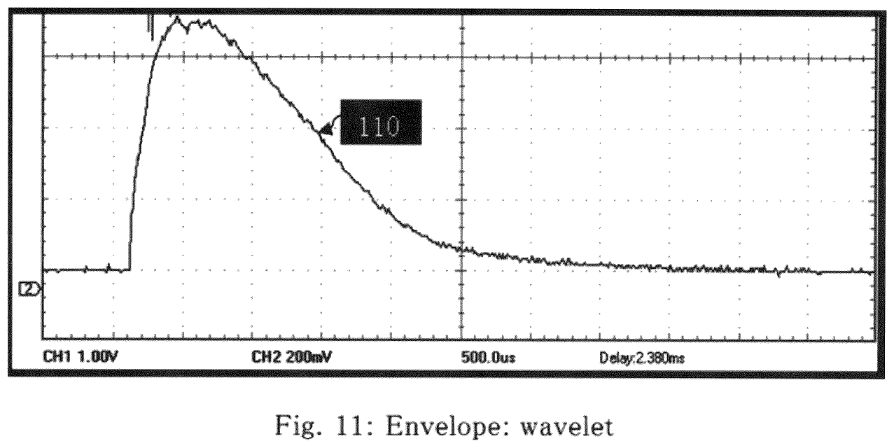

The present disclosure provides a probe 24 with a precise and known designed impact face 23, which provides a contact area that is known, controlled and repeatable, providing accuracy in measurement of sampled flow. Placing probe 24 on the bottom of a horizontal pipe 1 such that impact face 23 is at or near the bottom of the pipe 1 (see e.g. FIGS. 4a-4c), ensures that particles will be detected in lower or low flow rates when particles tend to sink towards the bottom of the pipe 1. Particles that are rolling along the bottom of the pipe 1 can also be detected. The present disclosure provides probes designed specifically for a specific and very repeatable impact response (impulse response) (see e.g. FIG. 6). This facilitates electronically extracting wavelets (see e.g. FIG. 11), and facilitates correlation software identification of valid impacts in noisy signals (see e.g. FIG. 13 wavelet correlation state diagram). The placement of probe 24 into the flow 200, rather than, for example, attempting to detect particles such as sand through the wall of a pipe, combined with a specific face, a specific impulse response, electronic hardware matched to extract a wavelet and a matched correlation engine solves, and improves the performance from conventional practice. After assembly, the pipe 1 with probe 24 inserted and piezoelectric device 3 epoxied to the probe 24 are calibrated, and further calibration in the field is not required. In an embodiment disclosed a length of pipe 1, into which the probe 24 intrudes provides a known or calibrated length of pipe 1, a distance upstream and/or a distance downstream of the probe 24. In an embodiment disclosed, the distance upstream is at least two times the diameter of the pipe 1 and preferably at least four times the diameter of the pipe 1. In an embodiment disclosed, the distance downstream is at least two times the diameter of the pipe 1 and preferably at least four times the diameter of the pipe 1.

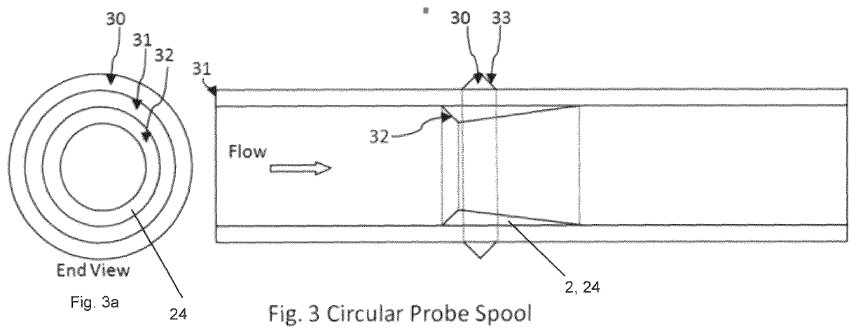

FIGS. 3-3a illustrates an embodiment of a probe of the present disclosure. In an embodiment disclosed, probe 24 is incorporated into a section of pipe or spool 31 to provide a machined circular particle impact surface 32 in flow 200 inside pipe or spool 31. The machined circular particle impact face 32 of probe 24 are integral to the section of pipe or spool 31. A solid ring 30, on the outside surface of the pipe or spool 31, is in ultrasonic acoustic communication with the impact surface 32. A mounting surface 33 is provided on the solid ring 30 opposite the particle impact surface 32. One or more piezoelectric devices 21 (not shown) are mounted on the mounting surface 33. In an embodiment disclosed, multiple piezoelectric device 21 are mounted on the mounting surface 32 for one or more of increased sensitivity, increased accuracy, velocity measurement, particle distribution, and flow regime measurements.

### Probe Mounting

FIGS. 4a-4c illustrates examples of probe mounting options. The device employs an intrusive probe 24, which is a steel probe inserted through the wall of pipe 1 with the impact face 23 exposed directly into the flow 200 of flowing liquids, gases or any combination thereof. There are many probe insertion orientations and configurations to place the impact face 23 in the flow 200. FIG. 4a illustrates a probe 24 inserted on an angle through the bottom of the pipe 1 with the particle impact face 23 oriented in an upstream direction. FIG. 4b illustrates a probe 24 inserted vertically through the wall of pipe 1, with a design imparted angled particle impact face 23 oriented in the upstream direction. FIG. 4c shows inserting a probe 24 through the pipe wall bottom, on an elbow. Inserting the probe into the lower portion of a pipe, elbow or other conduit or fitting, or at an angle, may optimize data collection quality. These probe orientations are good for comparative and/or calibration testing in open flow situations. The bottom insertion position also captures impact data from particles entrained by, rather than suspended in, the flow 200, especially suited for lower or slow flow velocities. In an embodiment disclosed, a recommended practice is pre-mounting the probe or probes 24 in sections of pipe (spool) and calibration testing (see e.g. FIG. 16) prior to installation in the field. As an example, probe 24 may be mounted to the pipe 1 by welding, threading, or otherwise.

### Impulse Response Design

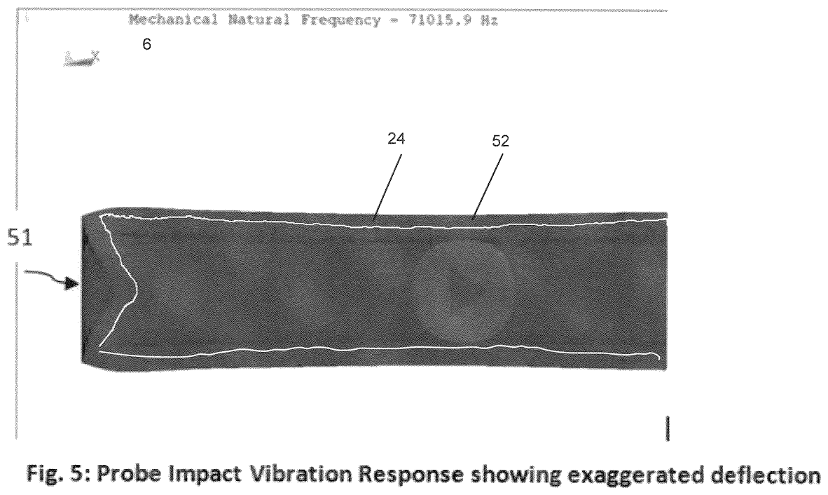

FIG. 5 is a diagram showing the designed vibrations in a probe of the present disclosure, e.g. a mathematical vibration design analysis 52. FIG. 5 shows, from a hollow tube design with an impact face 23 generally perpendicular the longitudinal Z-axis of the hollow tube, similar to that of FIG. 2a1, a still frame from a mathematical vibration design analysis video, captures the frequency 71.0159 kHz unique to the longitudinal Z-axis. It also showed a 77 kHz secondary frequency from another mode of vibration of the probe. It also showed a vibrating impact face, shown with exaggerated deflection 51.

In an embodiment disclosed, the probe vibrates in an ultrasonic frequency range, at greater than 20 KHz.

A probe 24 was built to the specification of the analyzed design of FIG. 5. Particle impact impulse response testing, using the manufactured probe with an affixed piezoelectric sensor 21 shows the impulse response 62 time domain signal (see e.g. FIG. 6). The envelope (see e.g. FIG. 11) of the waveform (see e.g. FIG. 6) is also unique to the probe design and its impulse response. It has a fast rising edge 61 and it has a logarithmic decline 60 with a half life of about 250 μs, in this particular probe design. The decline is also part of the unique response.

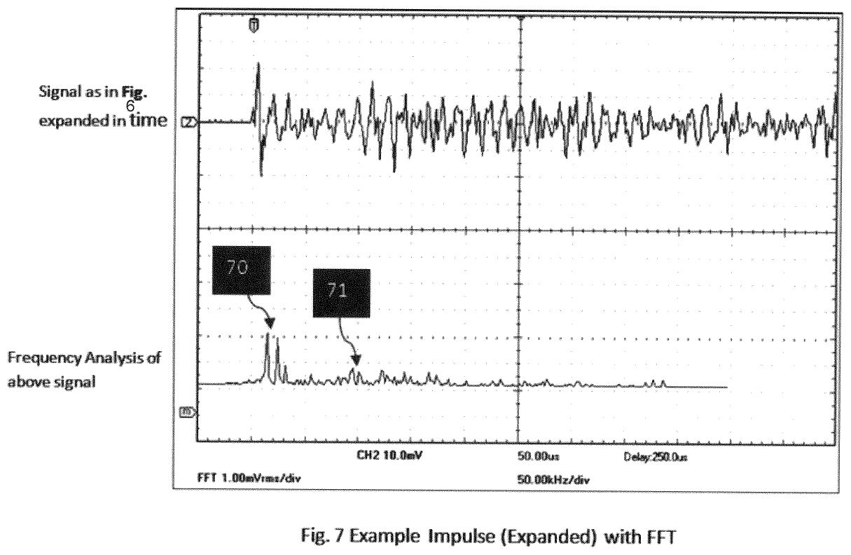

The corresponding Fast Fourier Transform (FFT) of the signal indicates its frequency content (see e.g. FIG. 7), revealing two frequencies in a range 70, between about 62 to 82 kHz, as per design, i.e. in this example the probe 24 of FIG. 5. There is also some energy in a range 71 around a 140 to 155 KHz range as expected when including first harmonics of the primary frequencies.

### Sensor Assembly

FIGS. 8a-8c illustrate a design and connection of a piezoelectric device 3 of the present disclosure.

A piezoelectric device 3, affixed to probe 24, monitors the mechanical response of the probe 24 and converts the mechanical vibration response to an electrical signal. The piezoelectric device 3 must be of the necessary frequency range and match the characteristic frequencies of the unique vibrations of the affixed probe 24. The conversion function is an integral part of the probe performance. A piezoelectric component generates the impulse response 62 observed in FIG. 6. Suitable piezo design specifications may include, for example, an enhanced 1-3 composite (Arrange & Fill) 2.25 MHZ, PZT 5A1 material, 250 μm if fiber diameter, 65% random fill epoxy matrix, CuSn electrode, poled. The probe 24 and piezoelectric device 3 are preferably substantially size matched in that the piezoelectric device 3 is sized to the diameter of the probe 24 where they are affixed, e.g. surface 20. This design element enhances capturing the fast rise times inherent in an impulse (see e.g. FIG. 6, fast rising edge 61). When the piezoelectric device 3 is under-diameter or over-diameter, the measurement may be degraded.

In an embodiment disclosed, the piezoelectric device 3 is two-sided insulated with contacts attached to the piezo facilitate insulating both sides of the piezo. Referring to FIGS. 8a-8c, piezoelectric device 3 includes piezo insulator 80, and piezo assembly 81 provides an output signal responsive to the probe 24 by connecting wires 86. An optional transition board 85 is available, providing positive and negative contact pads 82, 83 and coax connector 84 to assist in making vibration resistant or vibration proof wire connections 86 to contact pads 82/83. The coax connector 84 on the transition board is used to enable connection through coax cable 6 to electronics housing 7 (see FIG. 1).

### Electronics Signal Conditioning

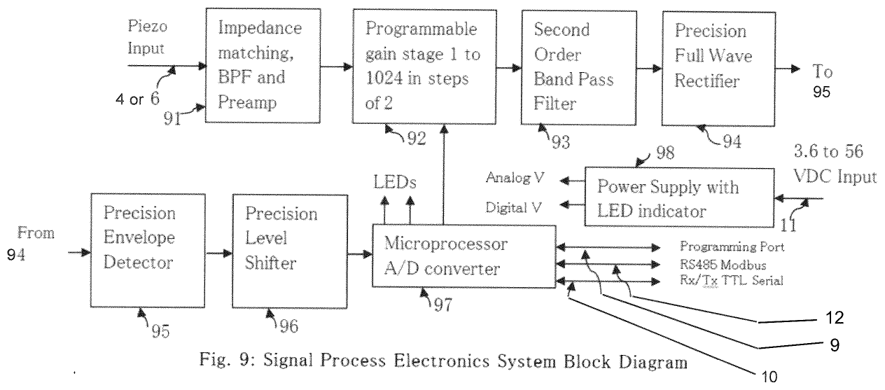

FIG. 9 is a simplified signal process electronics system block diagram of the present disclosure.

Since the probe 24 is designed to produce a specific and unique impulse response, a corresponding signal conditioning and identification method is disclosed. The signal from the piezoelectric device 3 is received by coax cable 6 at electronics and microprocessor 8. Impedance matching band pass filter and preamp 91 are applied. This block matches the impedance of the input amplifier to that of the piezoelectric device 3 for improved or maximum signal strength. This includes a band-pass filter which eliminates unwanted signal noise in the lower frequency (vibration and audio) that could be a source of interference and eliminates higher frequencies from other noise sources. It also removes higher frequencies in the actual signal which contributes little energy and information to the signal in the wavelet of interest.

Programmable gain stage 92 adjusts the signal amplitude to be within the range of the microprocessor analog/digital (A/D) power supply. This gain stage permits covering a very wide signal strength variation to compensate for factors such as particle size, velocity, mass, and impact location. It is a very high gain, low noise, fast response amplifier. It can be manually set but normally operates automatically under commands from the microprocessor 97.

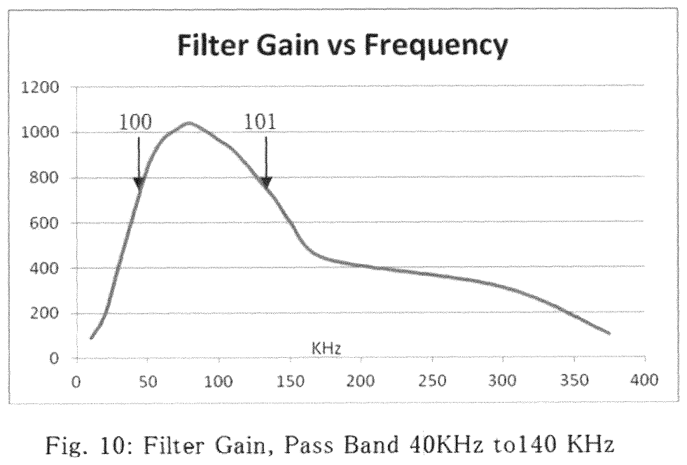

Second order band pass filter 93 passes the frequencies of interest and hence that of the unique signal impulse response of the probe 24/piezoelectric device 3, leaving only the frequencies of interest in the signal. This filter gain (see FIG. 10) eliminates unwanted signal noise in the lower frequency (vibration and audio) that could be a source of interference and eliminates higher frequencies from other noise sources such as switching noise, and higher frequencies. It also removes higher frequencies in the actual signal which contributes little energy and information to the signal of the impulse response. The resulting signal of the filtering process focuses on the unique mechanical impulse response.

FIG. 10 is the electronic filter frequency pass band of the second order filter block. Pass band has lower cutoff frequency 100 of 40 kHz, and upper cutoff frequency 101 of 140 kHz, which is for the example 71 kHz probe 24 of FIG. 5. In an embodiment disclosed, the pass band has a lower cutoff frequency of about half frequency and an upper cutoff frequency of double frequency of the designed probe 24, i.e. 0.5x to 2x.

Precision full wave rectifier 94 is applied to the impulse response to correct for the fact that the impulse response is not symmetrical in amplitude around its mean (see e.g. FIG. 6). This section produces a full wave rectified version of the impulse response capturing and retaining all the useful information in the signal. The precision nature of this block provides accuracy at very small signals and hence provides a wide dynamic range.

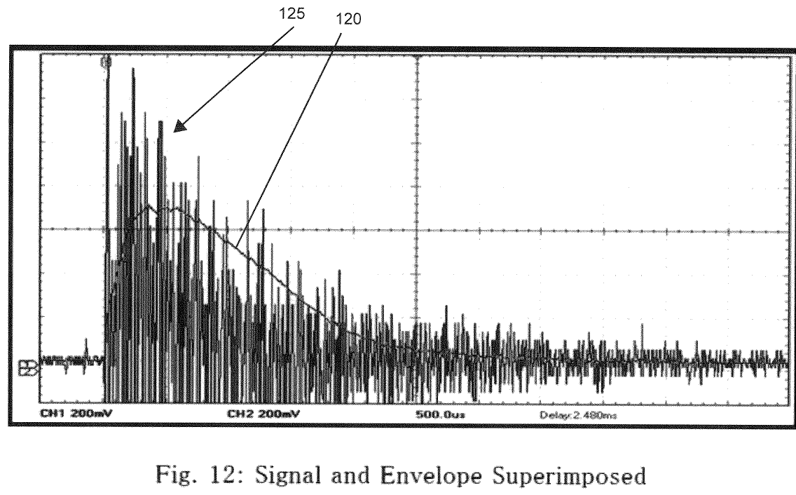

Precision envelope follower 95 of the rectified impulse response, produces a unique wavelet that accurately represents the envelope shape of the unique impulse response. The precision nature of this block provides accuracy at very small signals and hence provides a wide dynamic range (see FIG. 11). The result is a signal (wavelet) that is representative of both the frequency spectrum and amplitude sequence of the unique impulse response. The resulting wavelet (see FIGS. 11 and 12) is then fed to the microprocessor for signal processing.

Precision level shifter 96 adjusts the wavelet signal to be within the analog power supply range (A/D power supply range) for conversion to digital for microprocessor analysis. The signal is digitized through A/D converter in 97 for internal processing, communications, gain control, and operates two LEDs.

The device can be operated from a power supply 98 of 3.6V up to 56 volts. Including the microprocessor it draws less than 20 mA. Two separate power supplies are created, one low noise for analog signal components and one for digital devices.

### Microprocessor Signal Processing Software and Data Extraction

The incoming signal containing wavelets is digitized by the microprocessor analog/digital (A/D) converter of microprocessor 97. The sampling frequency used is 50 μs in the current example. Other sampling frequencies may be used. The sampling frequency controls how many samples are used to identify a wavelet, how quickly a wavelet can be identified and/or to what precision. A faster microprocessor could also be implemented for higher sampling frequencies. The combination of high sampling frequency with low power consumption is beneficial.

Each sample is measured for its energy content above an energy floor. The energy is accumulated over a time interval, for example one second. These values are compensated for temperature, gain, and linearity. The piezo is compensated for temperature by using an external software input of the flow temperature. Each sample analog/digital (A/D) value is averaged to provide a one second average count. This is used to determine noise levels. The number of samples taken are accumulated over one second and this sum is used to check sampling accuracy and software performance.

This signal containing noise and wavelets is monitored to identify wavelets. This is performed by wavelet correlation, a type of pattern recognition, a comparison of the received envelope waveform with the expected and known (as in FIG. 11) envelope waveform of a particle impact. Correlation may be implemented in various ways, by analog correlators, digital correlators, math processors, and digital signal processors, or in software or other methods. When the shape matches that of the known wavelet shape, the event is counted, indicating a particle impact (strike count) which are accumulated over one second. Rejected shapes are counted as well, separately, (reject count).

In the implementation described, the wavelet correlation is done in software, reducing required processing from other methods. This is due to the wavelet containing all the information required from the impact response, making the correlation inexpensive with low power consumption.

FIG. 11 illustrates the electronic signal (wavelet) in time fed to the microprocessor.

FIG. 12 illustrates superposition of wavelet 120 and electrical capture 125 of the vibrations.

FIG. 13 illustrates a wavelet correlation state diagram, e.g. software correlation state diagram identifying impacts (strikes).

The declaration of a good strike means that there has been a vertical edge steep enough to match the wavelet rising edge, see 130, and that a peak value has been identified 131 within the time frame as shown in FIG. 11, and that the falling edge, see 132 is also within the correct time frame and value, see 133, as calculated using the peak value which was identified in a previous state, see 131 and is used to adjust the falling value bounds as a percentage of the peak 133. In an example, these are set at 90% upper boundary and at 62.5% lower boundary.

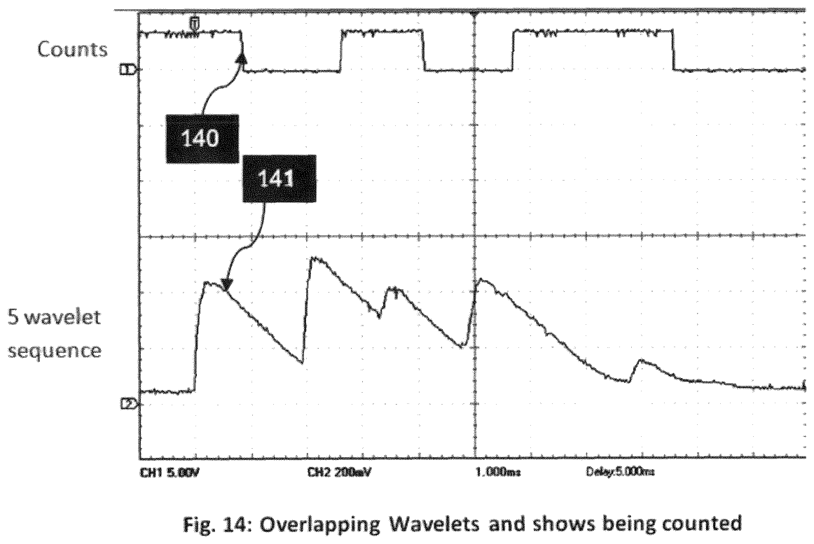

FIG. 14 is an electronic time sequence of a set of overlapping wavelets, and counting thereof. A counts line indicates a good count strike 140 shows each transition as a valid count. Many particles may hit closely in time resulting in overlapping wavelets 141. Correlation is very well suited to resolving these signals providing an accurate count of impacts.

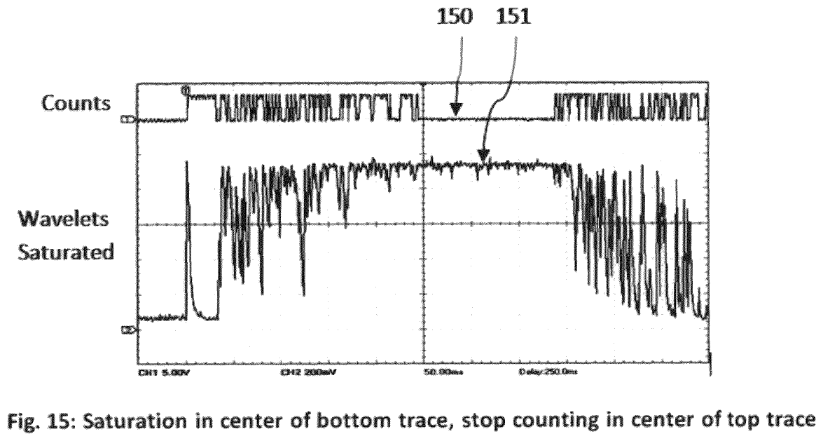

FIG. 15 is an electronic time sequence of a very large number of overlapping wavelets (saturated), and counting thereof.

If the number of particle impacts becomes numerous enough for the impacts to overlap completely 151, see FIG. 15, to the point where they cannot be individually discriminated and counted accurately, then an energy measure represented by the overlapping envelopes is calculated providing an accurate representation of the quantity of particles impacting the sensor. This situation can be described as the mechanical sensor being saturated with impacts, while the energy measure remains proportional to the mass and speed of particles. Every second, the strike count (the primary method) is used to qualify the energy (a secondary method) which represents the mass and is a novel method. The strikes and rejects as counted using the wavelet correlation technique are accumulated over one second called per second data values.

The energy that has been accumulated with every sample during a time period, for example one second is qualified every time period, for example one second:

A. The energy per second is compared to a maximum (Max Mass) possible value for sand impacts. If the value exceeds this value, then that seconds' energy is set to zero. This is due to the fact that such energy is deemed invalid, such as in an external impact on the pipe, or a major vibration well site disturbance. This is stored in an overstrike variable.

B. If there are no strikes, any energy is assumed to be noise and that seconds' energy is also set to zero.

C. The combination of A and B.

D. Otherwise, the energy and strikes per second are accumulated into running accumulations (sums), and then per second values are reset to 0 for the next second.

E. The strike floor is dynamically adjusted by comparing strikes per second to rejects per second: If strikes per second>4 times rejects per second, lower the strike floor; else raise the strike floor. The lowering or raising can be at various prescribed rates. The strike floor is not allowed to go below a lower limit set at manufacturing. This automated adjustment of the strike floor used in the “watching for rising edge” in the correlation state diagram, FIG. 13, 130, influencing identifying strikes (wavelets) is novel. The result is that the system adjusts automatically to the magnitude of the incoming signals reducing susceptibility to noise.

The operating system manages the data collected and other tasks every time period, for example every second. One or more of the following parameters are saved: average count per sec; samples per sec; rejects per second; strikes per second; strike sum; energy per second; energy sum; mass per second; mass sum; and strike floor.

Every time period, for example every second, the qualified energy per second is converted to micrograms per second and accumulated to create total micrograms. The energies represent the mass impacts on the sensor surface. To get total mass in the pipe, this per second energy (EPS) is converted to mass per second (M/s) and is then prorated for across the diameter of the pipe. This prorating and conversion to mass is done by multiplying the energies per second by a conversion factor (CF) which is dependent on the velocity, the energy per second measured, and the pipe diameter or type. FIG. 16 is an example of a conversion factor table used to convert energy to mass.

The conversion factors are stored in a table as in FIG. 16. This factor also accounts for the distribution of the particles in the flow, the position of the sensor in the flow, and the flow mechanism around the sensor. This conversion factor is a two dimensional table covering the range of sand concentration and velocities. The calculation uses the current measured energy per second (EPS) and velocity to look up the conversion factor (CF) in FIG. 16 to provide mass per second (M/s) as follows:

EPS*CF=M/s in micrograms/s (Equation1)

An example calculation from FIG. 16, at velocity 2.5 m/s, and energy per second of 41270, looking up the conversion factor is 83.1. Using equation (1) above:

41270*83.1=3,429,537 micrograms/s (Equation 2)

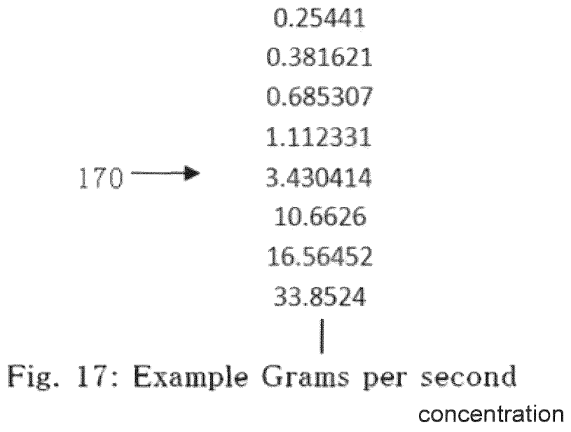

FIG. 17 is an example of the sand concentrations used to build the conversion factor (CF) table. This gives a mass per second of 3,429,537 micrograms per second, or 3.43 grams per second. This corresponds in this example with a mass per second concentration 170 seen in FIG. 17 of 3.43 grams per second which was used during production calibration.

When a velocity and/or energy per second falls between points in the two dimensions, an interpolation in each dimension is performed to get the conversion factor. For example from FIG. 16, if an EPS was measured at 30000 at a velocity of 2.25, two linear interpolations would first be done, one at 2 m/s between EPS 18626 (Factor 59.7), and 35505 (Factor 96.6) to get a new factor of X; the second interpolation at 2.5 M/s between EPS 41270 (Factor 83.1) and 24127 (Factor 46.1) to get a second factor of Y. A third interpolation between these two new factors X at 2 m/s and Y at 2.5 m/s will result in the correct factor for that current example of EPS 30000 and velocity 2.25.

### Calibration, Creating the Conversion Factor Table

Each unit has a conversion factor table as in FIG. 16, appropriate to the pipe size or type. Each unit can have its own table in order to calibrate for unit to unit probe manufacturing variations. The conversion factor table may be established, for example by calibration after assembly of the pipe 1 with probe 24 inserted and piezoelectric device 3 epoxied to the probe 24.

The conversion factors (CF) in FIG. 16 converts energy per second to mass per second. The table is a two dimensional table with energy per second in one dimension and velocity in the other. The conversion factors (CF) are what are entered into the intersection of each of the dimensions. The size of the table is variable depending on accuracy required. The building of the conversion factor (CF) table uses an empirical method performed using a complete pipe mounted unit with probe and piezo using actual flows with sand or other solid particles, in a flow loop.

Calibration is invoked via a maintenance port which runs the system using various sand concentrations and velocities as per FIG. 16 and automatically filling the table. The calibration is done using a flow loop whereby a constant mass per second of particles can be inserted into the flow which can be varied in velocity. At each velocity in the table, a set of mass per second concentration of particles (see FIG. 17), are inserted in the flow. Each resulting measured energy per second is recorded. The factor is calculated by dividing the known mass sand rate by the resulting energy per second, times 1,000,000 giving micrograms. This is done for each pipe type or even each unit if necessary. This sets the accuracy of mass reporting. This calibration is dependent on the accuracy and stability of the calibrating flow loop test system, including sand injection.

In the example FIG. 16 provided, the conversion factors (CF) are based on the fluid flow being water.

### Other System Functions

The operating system measures unit temperature and voltage at settable regular intervals in minutes, which are reported and used in energy calculation temperature compensations. In an embodiment disclosed, temperature and/or pressure data of the flow 200 are provided to the microprocessor 97 in order to provide adjustment, compensation, and/or enable further calculations and/or analysis.

Initial strike floor and energy floor settings are calculated at the time when the measuring unit (electronics and hardware) is combined with a probe 24 complete with piezoelectric sensor 3.

There is an RS485 9600 baud serial port which uses a RS485 modbus communications 12 protocol for communications to other devices such as the RTU 14 and/or a connection 15 to a host. This communications interface allows for the apparatus to be polled for all the information contained within and to be able to alter all user settable variables. Of particular importance are the average counts per sec, samples per sec, strikes per second, rejects per second, strike floor, strike sum, energy per second, energy sum, mass per second, and mass sum.

One or more programmable light emitting diodes (LEDs) (see FIG. 9) may provided to provide status and/or other information. One may be used as one second flash indicating proper operation.

There is a programming port 9 for the microprocessor FIG. 1.

Power supply monitoring is done automatically by detecting input voltage which triggers a controlled shutdown when it reaches VDD-5.91%. It stores all necessary parameters before power fails. It turns system back on again and restarts when voltage reaches VDD-4.55%. Power may be provided by one or more of utility power line, battery, solar, wind or other power source.

A regime floor is an input from the RTU or host to allow remote access to set the noise floor based on regime knowledge and/or data. A regime flow factor is an input from the RTU or Host to allow remote access to set a multiplication factor based on regime knowledge and/or data.

There is a maintenance port which is serial TTL 9600 baud. This is used for design, testing, manufacturing, system integration, and senior technician configurations.

It is expressly understood that the claimed invention is not to be limited to the description of the preferred embodiment but encompasses other modifications and alterations within the scope and spirit of the inventive concept.

In an embodiment disclosed, as used herein, solid particles may include solid particles experienced in flowing pipes, for example but not limited to oil and gas production. Examples of such solid particles may include one or more of sand, clays, shale, fracturing proppant, mineral scales, corrosion products such as rust, organic solids such as asphaltenes and waxes, welding slag, rust, scale, wax, asphaltenes, solder, precipitates, and combinations thereof. In a preferred embodiment, solid particles is substantially sand and/or fracturing proppant.

### Operation

In operation, a probe is configured to provide an identifiable frequency response in an ultrasonic frequency range. The probe, piezoelectric device and pipe are calibrated using a fluid. In an embodiment disclosed, the calibration uses a fluid and/or solid particles and/or flow rate and/or solid particle concentration at least similar to the planned use. When installed for the planned use, solid particles 210 flowing in the flow 200 impact the probe 24 to generate an impulse response generating the identifiable frequency and shape. The impulse response is recognized as disclosed herein, to provide a measurement of the solid particle content of the flow.

### Embodiments

Embodiments of the disclosure may include any combinations of the embodiments shown in the following lettered, numbered and Roman numeral paragraphs, including combinations crossing the lettered, numbered and Roman numeral paragraphs. This is not to be considered a complete listing of all possible embodiments, as any number of variations are envisioned from the description and drawings of the present application.

Embodiment A. An apparatus using methodologies disclosed herein to detect solid particles suspended in, and entrained by, flowing liquids, gases and combinations thereof. The apparatus combines physical, electronic and software components for detecting the presence and quantifying the mass of particles in flowing media. Pipe 1 with flow containing solid particles has a thru-pipe mounted design element for probe 2 on this apparatus, makes it directly applicable in the oil and gas sectors.

Embodiment B. An intrusive steel probe component of the apparatus provides impact surfaces for solid particles 50 micrometers (μm) and above. Each particle impact generates “ringing” along the probe. This is referred to as an impulse response. The material composition and design shape of the probe determines unique impulse response frequencies, durations, and amplitude envelope. The method and design controls the generation, and facilitates identification of the impulse response.

Embodiment C. The apparatus operates in the presence of noise. The apparatus design targets frequencies above 40 KHz, in the ultrasonic range, and below 1 MHz. The respective ranges are above typical audible noise such as low mechanical vibrations and other interferences from communications and switching noises. A piezoelectric device 3, affixed on the outer end of probe 2 converts the vibrations into an electrical signal. Electronics and microprocessor 8 isolates the impulse response signal, extracts an amplitude envelope wavelet from noise and correlation software identifies wavelets from remaining noise. The disclosed method and design facilitates identification of impulse responses, e.g. as wavelets.

Embodiment D. Counting each impulse response or particle impact facilitates calculating the quantity of solid particles under a wide variation of velocities and flow conditions. The energy of the impacts measured on the surface of the probe is proportional to the mass and their velocities. These two pieces of information, counts and energy (from which mass may be determined) provide the means to prorate the measurements to the amount of solid particles, e.g. sand flowing in a pipe. The method combining probe placement, designing probes with unique vibration impulse responses, e.g. to facilitate later detection of the vibration impulse response, matching electronic hardware and software for identifying impulse responses/extracting wavelets. It is low power due to methods used.

Embodiment 1. A probe designed to have a specific, unique vibration response to impacts. The response is dependent on the probe's shape, size, mounting and material composition. In one example a hollow probe was designed and tested for a specific particle impact impulse response, having a major frequency in perpendicular direction of 71.0159 kHz, and another major frequency of 77 kHz from another vibration mode. See FIG. 5 mathematical vibration design analysis. FIG. 5 is a still frame of a vibration analysis video showing the frequency in the longitude, Z axis. The designing of a probe with specific vibration response is novel. Each probe is designed to have its own set of unique vibration characteristics constitutes a variation disclosed herein. The specific envelope (FIG. 11) of the waveform (FIG. 6) including a steep rising edge parameters and its logarithmic decline is unique to the probe design. The decline is also part of the unique response.

Embodiment 2. Variations in probe design are contemplated. Examples of this are hollow sensor tubes, FIG. 2a, with the energy conversion device (piezo) placed at the internal end of the tube; and solid sensors, FIG. 2b, with the conversion device placed at the opposite end from the end placed in the flow. Different length and diameter probes and different shaped probe ends in the flow are contemplated herein, each designed to have specific, unique vibration response to impacts.

Embodiment 3. A pipe/probe combination (see FIGS. 3-3a) designed to have the surface built into the inside of the pipe with an opposite external piezo mounting, each designed to have specific, unique vibration response to impacts. This configuration allows for many other applications.

Embodiment 4. A placement option, of which there are many placement options for the probe in the flow, as in perpendicular, from the bottom, top, side, on an elbow, or at an angle when used in detecting solid particles in pipes. These can be used in open flows as well. The bottom position is preferable as it will include any particles running on the bottom of the pipe or open flow, especially good for slow velocities. These can be mounted on a section of pipe prior to installation, for example a spool.

Embodiment 5. A choice of the piezo material, the design of the piezo shape, the design of the insulation with contacts, creates a novel assembly maximizing signal while reducing noise. The example shown is for a solid probe.

Embodiment 6. Wiring is required from the piezo to the processing board. A transition board may be used between the piezo assembly and the input to the processing board to prevent wiring vibration, increase robustness against shock and to facilitate assembly. An example of a transition board is shown in FIG. 8c. The design of each is unique for each probe design and associated mounting technique.

Embodiment 7. An impedance matching BPF 93 and preamp 91 (FIG. 9) is unique to the novel piezo, the novel probe and its novel impulse response.

Embodiment 8. A second order band pass filter (BPF) 93 (FIG. 9) is a novel and unique design matched to the novel and unique impulse response of the novel and unique probe.

Embodiment 9. A precision full wave rectifier 94 (FIG. 9) is a novel and unique design matched to the novel and unique impulse response of the novel and unique probe. It captures the energy above and below the mean and ensures very low signal performance.

Embodiment 10. A precision envelope detector 95 (FIG. 9) is a novel and unique design matched to the novel and unique impulse response of the novel and unique probe.

Embodiment 11. A combination and/or sequence of BPF 93, PFWR 94 and PED 95 (FIG. 9) is a novel method of producing the unique wavelet matched to the unique impulse response of the novel and unique probe.

Embodiment 12. A combination and/or sequence of impedance matching and BPF 91, second order BPF 93, precision full wave rectifier 94 and precision envelope detector 95 of FIG. 9 and method of producing a unique wavelet matched to a unique impulse response of the unique probe when impacted by solid particulate.

Embodiment 13. A method including designing a probe with a unique and detectable impulse response and matching electronics signal processing to the designed probe impulse response.

Embodiment 14. A combination of high sampling frequency with low power consumption as disclosed herein.

Embodiment 15. A wavelet correlations state diagram as disclosed herein, e.g. FIG. 13 and related text. The declaration of a good strike means that there has been a vertical edge steep enough to match the wavelet rising edge, that a peak value has been identified within the time frame as prescribed in FIG. 10, and that the falling edge is also within the correct time frame and value, as dictated by the peak value which was identified in a previous state and is used to adjust the falling value bounds as a percentage of the peak. This is a unique feature of identifying a strike or impact. Many particles may hit closely in time resulting in overlapping envelopes. The correlation is very well suited to resolving these signals providing an increase in accuracy and/or accurate count of impacts. As an example, the first line 140 in FIG. 14 shows each transition as a valid count.

Embodiment 16. Counts (the primary method) used to qualify the energy as valid energy, and/or (a secondary method) which represents the mass.

Embodiment 17. A method to reduce or eliminate spurious noise where the energy per second is compared to a maximum (Max Mass) possible value for sand impacts. If the value exceeds this value, then that seconds' energy eliminated. This is due to the fact that such energy is deemed invalid, such as in an external impact on the pipe, or a major vibration well site disturbance. This is stored in an overstrike variable.

Embodiment 18. A method taking into account that when there are no strikes in a time period, for example a second, any energy is assumed to be noise and that time periods', e.g. seconds', energy is eliminated, since such energy is deemed invalid.

Embodiment 19. A combination of embodiment 17 and 18.

Embodiment 20. Automated adjustment of the strike floor used in the “watching for rising edge” in a correlation state diagram, e.g. FIG. 13, influencing identifying strikes (wavelets). The result is that the system adjusts automatically to the magnitude of the incoming signals reducing susceptibility to noise. While maintaining high accuracy in small wavelets.

Embodiment 21. Every time period, for example a second, the qualified energy per second is converted to micrograms per second and accumulated to create total micrograms. The energies represent the mass impacts on the sensor surface. To get total mass in the pipe, the per second energy (EPS) is converted to mass per second (M/s) and is then prorated across the diameter of the pipe. This prorating and conversion to mass is done by multiplying the energies per second by a conversion factor (CF) which is dependent on the velocity, the energy per second measured, and the pipe diameter or type. The conversion factors are stored in a table as in FIG. 16. This factor also accounts for the distribution of the particles in the flow, the position of the sensor in the flow, and the flow mechanism around the sensor. This conversion factor is a two dimensional table covering the range of sand concentration and velocities. The calculation uses the current measured energy per second and velocity to look up the conversion factor in FIG. 16. This a novel method of converting energy to mass and prorating to the whole pipe all in one calculation.

Embodiment 22. Each pipe type or cross section has its own conversion factor (CF) table, e.g. as in FIG. 16.

Embodiment 23. Each unit can have its own conversion factor (CF) table in order to calibrate for unit to unit probe manufacturing variations.

Embodiment 24. A method of building a conversion factor (CF) table, e.g. as in FIG. 16. The conversion factors (CF) in this table convert energy to mass per second as prorated for the pipe diameter. The table is a two dimensional table with energy per second in one dimension and velocity in the other, FIG. 16. The conversion factors are what are entered into the intersection of each of the dimensions. The size of the table is variable depending on accuracy required. When a velocity and/or energy per second falls between points in the two dimensions, an interpolation in each dimension is performed to get the conversion factor. The building of the conversion factor table uses an empirical method performed using a complete pipe mounted unit with sensor and piezo using actual flows with sand, a flow loop. It is invoked via the maintenance port which runs the system using various sand concentrations and velocities and automatically filling the table FIG. 16. The calibration is done using a flow loop whereby a constant mass per second of particles can be inserted into the flow which can be varied in velocity. At each velocity in the table, a set of mass per second particles, FIG. 17, are inserted in the flow. Each resulting measured energy per second becomes the look up variable in the energy dimension of the table at the current velocity. The factor is calculated by dividing the known mass sand rate, which was used in the test, by the resulting energy per second, times 1,000,000 giving micrograms. This is done for each pipe type or even each unit if necessary. This sets the accuracy of mass reporting. This calibration is dependent on the accuracy and stability of the calibrating flow loop test system, including sand injection.

Embodiment 25. A computer implemented method, operating system, software, or computer program product to implement the method disclosed herein. Unit temperature and/or voltage is measured at settable regular intervals in minutes, which is/are reported and used in energy calculations.

Embodiment 26. A method including setting and/or adjusting a flow regime noise floor, for example by an input to allow remote access to set the noise floor based on regime knowledge.

Embodiment 27. A method including setting and/or adjusting a flow regime flow factor, for example by an input to allow remote access to set a correction factor based on regime knowledge.

Embodiment I. A method of detecting solid particles in a fluid flow comprising: providing a probe into the fluid flow, the probe adapted to vibrate at a frequency in an impulse response envelope to the solid particles; and detecting the frequency and impulse response envelope.

Embodiment II. The Method of Embodiment I, Wherein the Frequency is in an Ultrasonic Range.

Embodiment III. The method of embodiment I or II, wherein the frequency and impulse response envelope is predetermined by mechanical configuration of the probe.

Embodiment IV. The method of any one of embodiments I to III, wherein detecting the frequency and impulse response envelope comprises extracting wavelets from the impulse response.

Embodiment V. A system for detecting solid particles in a fluid flow comprising: a probe for insertion into the fluid flow, the probe adapted to vibrate at a frequency in an impulse response envelope to the solid particles; a piezoelectric device in ultrasonic communication with the probe, adapted to convert impulse response vibration into an electronic signal; and a detector, adapted to identify the impulse response in the electronic signal.

Embodiment VI. The system of embodiment V, further comprising a section pipe, the probe inserted through a wall of the section of pipe into the fluid flow.

Embodiment VII. The system of embodiment V or VI, wherein the probe has an impact face proximate a first end of the probe and a sensor mounting surface in ultrasonic acoustic communication with the impact face, wherein the impact face is adapted to intrude into the fluid flow, and wherein the piezoelectric device is affixed to the sensor mounting surface.

Embodiment VIII. The system of any one of embodiments V to VII, wherein the probe is at least partially hollow.

Embodiment IX. The system of any one of embodiments V to VIII, wherein the impact face is angled relative to a body of the probe.

Embodiment X. The system of any one of embodiments V to IX, wherein the impact face is angled relative to a direction of the fluid flow.

Embodiment XI. The system of any one of embodiments V to X, further comprising a section of pipe and a ring on an outside of the section of pipe, wherein the probe comprises a shaped tubular inside the section of pipe, the shaped tubular having an impact face and the ring having a sensor mounting surface, wherein the impact face and the sensor mounting surface are in ultrasonic acoustic communication.

Embodiment XII. The system of embodiment XI, wherein the ring is proximate the impact face.

Embodiment XIII. The system of embodiment XI or XII, where the shaped tubular comprises a cross-section profile, wherein the cross-section profile is triangular.

Embodiment XIV. The system of any one of embodiments XI to XIII, wherein the probe, the section of pipe, and the ring are a unitary body.

Embodiment XV. A probe for insertion into a fluid flow for detecting solid particles in the fluid flow, the probe adapted to vibrate at a frequency and impulse response envelope to the solid particles, the probe comprising an impact face proximate a first end of the probe and a sensor mounting surface in ultrasonic acoustic communication with the impact face, the impact face adapted to intrude into the fluid flow.

Embodiment XVI. The probe of embodiment XV, further comprising a section of pipe and a ring on an outside of the section of pipe, wherein the probe comprises a shaped tubular inside the section of pipe, the shaped tubular having the impact face and the ring having the sensor mounting surface.

Embodiment XVII. The probe of embodiment XV or XVI, further comprising a piezoelectric device in ultrasonic acoustic communication with the probe, adapted to convert impulse response vibration into an electronic signal.

### Scope

While specific embodiments have been described and illustrated, such embodiments should be considered illustrative of the subject matter described herein and not as limiting the claims as construed in accordance with the relevant jurisprudence.

1. A method of detecting solid particles in a fluid flow comprising:
providing a probe into the fluid flow, the probe adapted to vibrate at a frequency in an impulse response envelope to the solid particles; and
detecting the frequency and impulse response envelope.

2. The method of claim 1, wherein the frequency is in an ultrasonic range.

3. The method of claim 1, wherein the frequency and impulse response envelope is predetermined by mechanical configuration of the probe.

4. The method of claim 1, wherein detecting the frequency and impulse response envelope comprises extracting wavelets from the impulse response.

5. A system for detecting solid particles in a fluid flow comprising:
a probe for insertion into the fluid flow, the probe adapted to vibrate at a frequency in an impulse response envelope to the solid particles;
a piezoelectric device in ultrasonic communication with the probe, adapted to convert impulse response vibration into an electronic signal; and
a detector, adapted to identify the impulse response in the electronic signal.

6. The system of claim 5, further comprising a section pipe, the probe inserted through a wall of the section of pipe into the fluid flow.

7. The system of claim 5, wherein the probe has an impact face proximate a first end of the probe and a sensor mounting surface in ultrasonic acoustic communication with the impact face, wherein the impact face is adapted to intrude into the fluid flow, and wherein the piezoelectric device is affixed to the sensor mounting surface.

8. The system of claim 5, wherein the probe is at least partially hollow.

9. The system of claim 5, wherein the impact face is angled relative to a body of the probe.

10. The system of claim 5, wherein the impact face is angled relative to a direction of the fluid flow.

11. The system of claim 5, further comprising a section of pipe and a ring on an outside of the section of pipe, wherein the probe comprises a shaped tubular inside the section of pipe, the shaped tubular having an impact face and the ring having a sensor mounting surface, wherein the impact face and the sensor mounting surface are in ultrasonic acoustic communication.

12. The system of claim 11, wherein the ring is proximate the impact face.

13. The system of claim 11, where the shaped tubular comprises a cross-section profile, wherein the cross-section profile is triangular.

14. The system of claim 11, wherein the probe, the section of pipe, and the ring are a unitary body.

15. A probe for insertion into a fluid flow for detecting solid particles in the fluid flow, the probe adapted to vibrate at a frequency and impulse response envelope to the solid particles, the probe comprising:
an impact face proximate a first end of the probe and a sensor mounting surface in ultrasonic acoustic communication with the impact face, the impact face adapted to intrude into the fluid flow.

16. The probe of claim 15, further comprising a section of pipe and a ring on an outside of the section of pipe, wherein the probe comprises a shaped tubular inside the section of pipe, the shaped tubular having the impact face and the ring having the sensor mounting surface.

17. The probe of claim 15, further comprising a piezoelectric device in ultrasonic acoustic communication with the probe, adapted to convert impulse response vibration into an electronic signal.
